(19) United States
(12) Patent Application Publication
(10) Pub. No.: US 2026/0187894 A1
(43) Pub. Date: Jul. 2, 2026

(54) DRAWING ANIMATION GENERATION METHOD AND APPARATUS, DEVICE, READABLE STORAGE MEDIUM, AND PRODUCT

(71) Applicant: Beijing Zitiao Network Technology Co., Ltd., Beijing (CN)

(72) Inventors: Yubin YU, Beijing (CN); Dayu QIU, Beijing (CN); Lintong ZHAO, Beijing (CN); Qiuhan HUANG, Beijing (CN); Jing DU, Beijing (CN); Qiuhu TANG, Beijing (CN)

(21) Appl. No.: 18/868,145

(22) PCT Filed: Aug. 28, 2023
(86) PCT No.: PCT/CN2023/115331

§ 371 Date: Nov. 21, 2024

(30) Foreign Application Priority Data
Sep. 1, 2022 (CN) 202211068030.7

(51) Int. Cl. G06T 13/80; G06T 11/23

(52) U.S. Cl. CPC G06T 13/80; G06T 11/23

(57) ABSTRACT

Embodiments of the present disclosure provide a drawing animation generation method and apparatus, an electronic device, a computer-readable storage medium, a computer program product, and a computer program. The method includes: acquiring, in response to a drawing animation generation request triggered by a user for a target line, line drawing information corresponding to the target line, where the line drawing information includes a stroke snapshot, a stroke bounding box, and a drawing track which are corresponding to at least part of strokes in the target line, and the target line is composed of a plurality of strokes; and drawing, according to the drawing animation generation request and by using the line drawing information, the at least part of the strokes corresponding to the target line, to generate a drawing animation corresponding to the target line.

### CROSS-REFERENCE TO RELATED APPLICATION

This application is a national stage of International Application No. PCT/CN2023/115331, filed on Aug. 28, 2023, which claims priority to Chinese Patent Application No. 202211068030.7, filed on Sep. 1, 2022. Both of the aforementioned applications are hereby incorporated by reference in their entireties.

### TECHNICAL FIELD

Embodiments of the present disclosure relate to the technical field of image processing, and in particular, to a drawing animation generation method and apparatus, an electronic device, a computer-readable storage medium, a computer program product, and a computer program.

### BACKGROUND

In video editing software, a graffiti function for a video is provided to improve a video effect after editing. A user may add graffiti in a video according to an actual requirement.

In an existing graffiti, a large number of small squares are stacked together to form a graffiti track during a drawing process. When the user needs to review the drawing process, it is required to redraw all small squares corresponding to a graffiti track in an image of each frame, which places a high demand on a performance of a terminal device. When the terminal device has poor performance, a freeze occurs, and the drawing process cannot be reproduced.

### SUMMARY

The embodiments of the present disclosure provide a drawing animation generation method and apparatus, an electronic device, a computer-readable storage medium, a computer program product, and a computer program, to solve technical problems that existing graffiti drawing animation generation methods have high requirements on device performance and a reproduction process is time-consuming and prone to freeze.

In a first aspect, an embodiment of the present disclosure provides a drawing animation generation method, including:
acquiring, in response to a drawing animation generation request triggered by a user for a target line, line drawing information corresponding to the target line, where the line drawing information includes a stroke snapshot, a stroke bounding box, and a drawing track which are corresponding to at least part of strokes in the target line, and the target line is composed of a plurality of strokes; and
drawing, according to the drawing animation generation request and by using the line drawing information, the at least part of the strokes corresponding to the target line, to generate a drawing animation corresponding to the target line.

In a second aspect, an embodiment of the present disclosure provides a drawing animation generation apparatus, including:
an acquiring module, configured to acquire, in response to a drawing animation generation request triggered by a user for a target line, line drawing information corresponding to the target line, where the line drawing information includes a stroke snapshot, a stroke bounding box, and a drawing track which are corresponding to at least part of strokes in the target line, and the target line is composed of a plurality of strokes; and
a drawing module, configured to draw, according to the drawing animation generation request and by using the line drawing information, the at least part of the strokes corresponding to the target line, to generate a drawing animation corresponding to the target line.

In a third aspect, an embodiment of the present disclosure provides an electronic device, including: a processor and a memory;
where the memory stores a computer-executable instruction; and
the processor executes the computer-executable instruction stored in the memory, to enable the processor to execute the drawing animation generation method according to the first aspect and various possible designs of the first aspect.

In a fourth aspect, an embodiment of the present disclosure provides a computer-readable storage medium, where the computer-readable storage medium stores a computer-executable instruction, and when a processor executes the computer-executable instruction, the drawing animation generation method according to the first aspect and the various possible designs of the first aspect is implemented.

In a fifth aspect, an embodiment of the present disclosure provides a computer program product, including a computer program, where when the computer program is executed by a processor, the drawing animation generation method according to the first aspect and the various possible designs of the first aspect is implemented.

In a sixth aspect, an embodiment of the present disclosure provides a computer program, where when the computer program is executed by a processor, the drawing animation generation method according to the first aspect and the various possible designs of the first aspect is implemented.

In the drawing animation generation method and apparatus, the electronic device, the computer-readable storage medium, the computer program product, and the computer program provided in the embodiments, by pre-storing a stroke snapshot, a stroke bounding box, and a drawing track which are corresponding to each stroke in the target line, when the drawing animation generation request triggered by the user is acquired, reproduction of the drawing process of the target line can be quickly implemented according to the stroke snapshot and the stroke bounding box. It is not required to redraw all small squares for each stroke, thereby effectively improving generation efficiency of a drawing animation and avoiding a freeze of a terminal device.

### BRIEF DESCRIPTION OF DRAWINGS

To describe technical solutions in the embodiments of the present disclosure or in the related art more clearly, the following briefly describes drawings used for describing the embodiments or the related art. Apparently, the drawings in the following description show some embodiments of the present disclosure, and a person of ordinary skill in the art may still derive other drawings from these drawings without creative efforts.

FIG. 1 is a flow diagram of a drawing animation generation method provided by an embodiment of the present disclosure.

FIG. 2 is a flow diagram of a drawing animation generation method provided by another embodiment of the present disclosure.

FIG. 3 is a diagram of drawing of a drawing animation provided by an embodiment of the present disclosure.

FIG. 4 is a flow diagram of a drawing animation generation method provided by yet another embodiment of the present disclosure.

FIG. 5 is a diagram of a target line drawn by using a material brush provided by an embodiment of the present disclosure.

FIG. 6 is a flow diagram of a drawing animation generation method provided by yet another embodiment of the present disclosure.

FIG. 7 is a structural diagram of a drawing animation generation apparatus provided by an embodiment of the present disclosure.

FIG. 8 is a structural diagram of an electronic device provided by an embodiment of the present disclosure.

### DESCRIPTION OF EMBODIMENTS

To make purposes, technical solutions, and advantages of the embodiments of the present disclosure clearer, the technical solutions in the embodiments of the present disclosure are described clearly and completely below with reference to the drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

### Term Explanations

bounding box: an algorithm for solving an optimal bounding space of a discrete point set, and a basic idea is to approximately replace a complex geometric object with a geometry (referred to as a bounding box) with a slightly larger volume and a simple feature.

To solve the technical problems that the existing graffiti drawing animation generation methods have high requirements on a performance of a terminal device and an animation drawing process is prone to freeze, the present disclosure provides a drawing animation generation method and apparatus, a device, a readable storage medium, and a product.

It should be noted that the drawing animation generation method and apparatus, the electronic device, the computer-readable storage medium, the computer program product, and the computer program provided in the present disclosure may be applied to any application scenario in which a drawing process needs to be reproduced.

In an existing graffiti drawing process, each stroke is composed of a plurality of small squares, and a final graffiti pattern is composed of respective strokes. Therefore, in a graffiti drawing animation generation process, each small square in the graffiti pattern also needs to be redrawn. Therefore, when there are relatively many strokes in the graffiti pattern, relatively many small squares need to be drawn, which may cause a freeze in drawing and affect user experience.

In a process of solving the above technical problems, the inventors have found through research that to quickly reproduce a drawing process, a stroke snapshot, a stroke bounding box, and a drawing track which are corresponding to each stroke in a target line can be pre-stored, so that when a drawing animation generation request triggered by a user is acquired, reproduction of the drawing process of the target line can be quickly implemented based on the stroke snapshot and the stroke bounding box. Therefore, there is no need to redraw a large number of small squares, which avoids a freeze in drawing.

### Embodiment 1

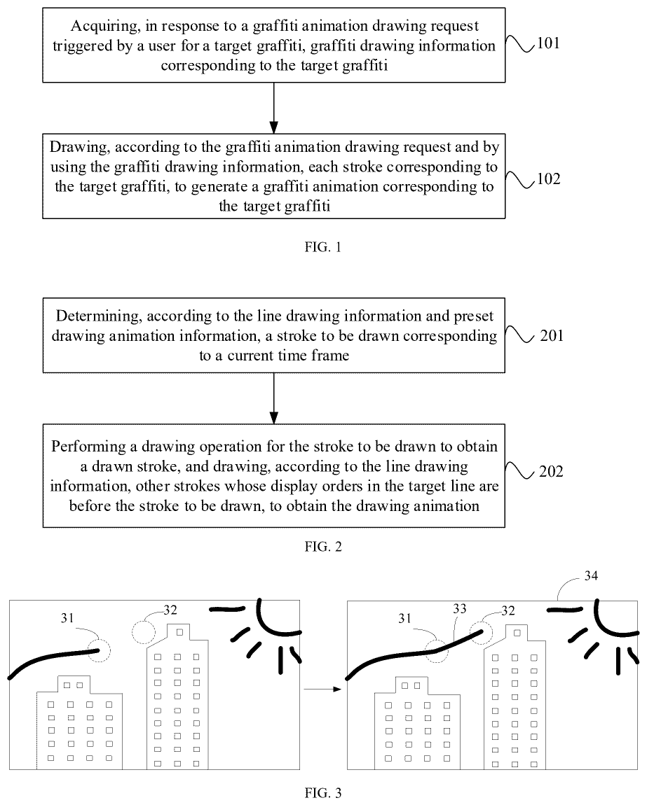

FIG. 1 is a flow diagram of a drawing animation generation method provided by an embodiment of the present disclosure. As shown in FIG. 1, the method includes following steps.

Step 101: acquiring, in response to a drawing animation generation request triggered by a user for a target line, line drawing information corresponding to the target line, where the line drawing information includes a stroke snapshot, a stroke bounding box, and a drawing track which are corresponding to at least part of strokes in the target line, and the target line is composed of a plurality of strokes.

An execution subject of the present embodiment is a drawing animation generation apparatus, and the drawing animation generation apparatus may be coupled to a terminal device. Therefore, a drawing animation corresponding to the target line may be generated according to an instruction triggered by a user on the terminal device. In an embodiment, the drawing animation generation apparatus may be coupled to a server. The server is communicatively connected to the terminal device, so that a drawing animation generation request sent by the terminal device can be acquired, a drawing animation is generated according to the drawing animation generation request, and the generated drawing animation is fed back to the terminal device for playing.

In this implementation, the user may perform an editing operation on a target video or a target image on the terminal device. For example, a freehand-drawn line may be added to the target video or the target image, and a line corresponding to a plurality of strokes drawn by the user is used as the target line. In an embodiment, the target line may be displayed in a form of graffiti.

To facilitate the user's review of a drawing process in a subsequent process, during the drawing process, line drawing information corresponding to the target line may be stored, where the line drawing information includes a stroke snapshot, a stroke bounding box, and a drawing track which are corresponding to each stroke in the target line. The stroke snapshot can represent a drawing status corresponding to a certain stroke, and the stroke bounding box can represent an optimal bounding space of the stroke.

The stroke snapshot may be an image corresponding to a stroke. In a process in which the user draws the target line, for each sliding operation of the user on a screen, a stroke drawn by the user may be determined according to the sliding operation. Each stroke is drawn and stored in a separate page to obtain a stroke snapshot. After the user completes a drawing operation for the target line, stored stroke snapshots of all strokes may be combined and displayed to obtain the target line.

When the user completes drawing of the target line, a drawing animation generation request for the target line may be generated by using a preset trigger control, to review the drawing process of the target line. Correspondingly, the drawing animation generation apparatus may acquire the pre-stored line drawing information in response to the drawing animation generation request.

Step 102: drawing, according to the drawing animation generation request and by using the line drawing information, the at least part of the strokes corresponding to the target line, to generate a drawing animation corresponding to the target line.

In this implementation, after the line drawing information is acquired, a drawing operation may be performed for the at least part of the strokes corresponding to the target line according to the line drawing information in a drawing order, to generate the drawing animation corresponding to the target line.

It should be noted that the user may select a stroke that needs to be drawn according to an actual requirement. For example, the user may select to redraw all the strokes in the target line. Alternatively, the user may select a part of strokes in the target line to generate a drawing animation, which is not limited in the present disclosure.

Therefore, there is no need to redraw all small squares corresponding to the target line, thereby effectively avoiding a freeze in the drawing process.

Further, on the basis of any one of the foregoing embodiments, the drawing animation generation request includes an animation type.

Step 102 includes:
drawing, by using a drawing method corresponding to the animation type and according to the line drawing information, the at least part of the strokes corresponding to the target line, to generate the drawing animation corresponding to the target line.

In the present embodiment, to enrich a display effect of the drawing animation, different animation types may be preset. For example, the animation types may include an entrance animation type, an exit animation type, and a loop animation type. The entrance animation type may be configured as an animation of gradually drawing respective strokes, and the exit animation type may be configured as an animation in which the respective strokes gradually disappear. The loop animation type may be configured as an animation in which the target line is displayed in a loop based on a preset animation editing element.

When triggering the drawing animation generation request, the user may select the animation type at the same time.

Correspondingly, to enable the generated drawing animation to match an actual requirement of the user, the at least part of the strokes corresponding to the target line may be drawn according to the line drawing information and by using the drawing method corresponding to the animation type, to generate the drawing animation corresponding to the target line.

In the drawing animation generation method provided in the present embodiment, by pre-storing the stroke snapshot, the stroke bounding box, and the a drawing track which are corresponding to each stroke in the target line, when the drawing animation generation request triggered by the user is acquired, the reproduction of the drawing process of the target line can be quickly implemented according to the stroke snapshot and the stroke bounding box. There is no need to redraw all the small squares for each stroke, thereby effectively improving a generation efficiency of the drawing animation and avoiding a freeze of the terminal device.

### Embodiment 2

FIG. 2 is a flow diagram of a drawing animation generation method provided by another embodiment of the present disclosure. On the basis of any one of the foregoing embodiments, the animation type includes an entrance animation type and/or an exit animation type. As shown in FIG. 2, the drawing, by using a drawing method corresponding to the animation type and according to the line drawing information, the at least part of the strokes corresponding to the target line, to generate the drawing animation corresponding to the target line includes following steps.

Step 201: determining, according to the line drawing information and preset drawing animation information, a stroke to be drawn corresponding to a current time frame, where the drawing animation information includes a drawing duration and/or a drawing speed corresponding to the drawing animation.

Step 202: performing a drawing operation for the stroke to be drawn to obtain a drawn stroke, and drawing, according to the line drawing information, other strokes whose display orders in the target line are before the stroke to be drawn, to obtain the drawing animation.

In the present embodiment, the animation type may specifically be the entrance animation type and/or the exit animation type. The entrance animation type may be configured as an animation of gradually drawing respective strokes, and the exit animation type may be configured as an animation in which the respective strokes gradually disappear.

To effectively avoid a freeze in the drawing animation, the drawing animation may be generated by using a combination of stroke drawing and a stroke snapshot. Specifically, the preset drawing animation information may be acquired, where the drawing animation information may be set by the user based on an actual requirement when the user triggers the drawing animation generation request. The drawing animation information may include the drawing duration and/or the drawing speed corresponding to the drawing animation. For example, the user may set the drawing duration of the drawing animation to 30 seconds. Therefore, the strokes in the drawing animation may be controlled to be drawn at a uniform speed, and the drawing ends after 30 seconds.

After the drawing animation information is acquired, the stroke to be drawn corresponding to the current time frame may be determined according to the drawing animation information and the line drawing information. For the stroke to be drawn, the drawing operation may be performed for the stroke to be drawn. For the other strokes whose display orders in the target line are before the stroke to be drawn, to avoid a freeze of the terminal device caused by drawing the other strokes, a drawing operation may be performed for the other strokes according to stroke snapshots in the line drawing information to obtain the drawing animation.

Further, on the basis of any one of the foregoing embodiments, step 202 includes:
determining, according to the line drawing information, the stroke snapshots corresponding to the other strokes; and
performing a combination operation on the drawn stroke and the stroke snapshots corresponding to the other strokes, to generate the drawing animation corresponding to the target line.

In the present embodiment, for the other strokes whose display orders in the target line are before the stroke to be drawn, the stroke snapshots corresponding to the other strokes may be determined in the line drawing information. The stroke snapshots corresponding to the other strokes are combined with the drawn stroke to generate the drawing animation corresponding to the target line.

Further, on the basis of any one of the foregoing embodiments, step 201 includes:
determining, according to a total length corresponding to all the strokes in the target line and the drawing animation information, a drawing time period corresponding to each stroke; and
determining the current time frame, determining a drawing time period matching the current time frame, and determining a stroke corresponding to the drawing time period as the stroke to be drawn.

In the present embodiment, for all the strokes in the target line, the total length corresponding to all the strokes may be calculated first. The drawing time period corresponding to each stroke is determined according to the total length and the drawing animation information. In a process of generating the drawing animation, the current time frame is determined, and the stroke corresponding to the drawing time period matching the time frame is used as the current stroke to be drawn.

In the drawing animation generation method provided in the present embodiment, the drawing animation is generated by using the combination of the stroke drawing and the stroke snapshot, so that a freeze of the terminal device can be effectively avoided. In addition, the generation efficiency of the drawing animation can be improved.

Further, on the basis of any one of the foregoing embodiments, when the animation type is the entrance animation type, and an animation drawing order is a sequential drawing order, and/or when the animation type is the exit animation type, and the animation drawing order is an inverted drawing order, step 202 includes:
determining, according to the drawing animation information, the total length corresponding to all the strokes in the target line, and the drawing track, a first drawing position corresponding to the current time frame and a second drawing position corresponding to a next time frame; and
performing an incremental drawing operation on a to-be-drawn area between the second drawing position and the first drawing position, until the drawing operation for the stroke to be drawn is completed, to obtain the drawn stroke.

In the present embodiment, for the entrance animation type and the exit animation type, there are two respectively corresponding drawing methods: sequential drawing and inverted drawing. The sequential drawing is to draw in a drawing direction of the user, and the inverted drawing is to draw in a direction opposite to the drawing direction of the user. For example, if the user completes the drawing of the target line in an order from left to right, the sequential drawing is to display a drawing process in the drawing animation in an order from left to right, and the inverted drawing is to display the drawing process in the drawing animation in an order from right to left.

Accordingly, the sequential drawing in the entrance animation is to control strokes to be gradually drawn based on a drawing order of the user, and the inverted drawing in the exit animation is to control the strokes to gradually disappear based on an order opposite to the drawing order of the user.

Specifically, in the foregoing application scenario, a stroke is displayed in a form of an increment, that is, a length of the stroke drawn in a next frame is greater than a length of the stroke drawn in a last frame. Therefore, for the foregoing application scenario, the drawing operation for the stroke to be drawn may be performed by using an incremental drawing method.

For the current time frame, the first drawing position corresponding to the current time frame is determined according to the drawing animation information, the total length corresponding to all the strokes in the target line, and the drawing track. A next time frame with a preset time interval from the current time frame is determined, and the second drawing position corresponding to the next time frame is determined according to the drawing animation information, the total length corresponding to all the strokes in the target line, and the drawing track.

The to-be-drawn area between the first drawing position and the second drawing position is determined, and incremental drawing is performed on the to-be-drawn area based on the current time frame. After the incremental drawing on the stroke to be drawn is completed, the drawn stroke is obtained.

FIG. 3 is a diagram of drawing of a drawing animation provided by an embodiment of the present disclosure. As shown in FIG. 3, when a drawing order is a sequential drawing order, a first drawing position 31 corresponding to a current time frame and a second drawing position 32 corresponding to a next time frame may be determined. Incremental drawing is performed on a to-be-drawn area 33 between the first drawing position 31 and the second drawing position 32 to obtain a drawing result 34. After drawing of all of a target line is completed, a drawing animation is obtained.

In the drawing animation generation method provided in the present embodiment, a drawing operation on a stroke to be drawn is performed by using an incremental drawing method, so that an efficiency of a drawing operation can be effectively improved, resource occupancy in a drawing process is low, a freeze is avoided, and user experience is improved.

Further, on the basis of any one of the foregoing embodiments, when the animation type is the entrance animation type, and the animation drawing order is an inverted drawing order, and/or when the animation type is the exit animation type, and the animation drawing order is a sequential drawing order, step 202 includes:
determining a drawn length corresponding to the stroke to be drawn at the current time frame;
determining, according to the drawing animation information and a time difference between the current time frame and the next time frame, a target drawing length corresponding to the next time frame; and
performing a full drawing operation for the target drawing length of the stroke to be drawn at the next time frame, to obtain the drawn stroke.

In the present embodiment, when the animation type is the entrance animation type, and the animation drawing order is the inverted drawing order, it is represented that the animation is an animation of gradually drawing the strokes in an order opposite to the drawing order of the user. When the animation type is the exit animation type, and the animation drawing order is the sequential drawing order, it is represented that the animation is an animation in which the strokes disappear in an order the same as the drawing order of the user. That is, in the foregoing application scenario, a drawn length of each stroke at a current time frame is greater than a drawn length at a next time frame. Therefore, to realize the foregoing animation effect, the stroke to be drawn at each time frame needs to be drawn by using a full drawing method.

In an embodiment, the drawn length corresponding to the stroke to be drawn at the current time frame may be determined. The target drawing length corresponding to the next time frame is determined according to the drawing animation information and the time difference between the current time frame and the next time frame. The full drawing operation is performed for the target drawing length of the stroke to be drawn at the next time frame to obtain the drawn stroke.

In the drawing animation generation method provided in the present embodiment, the full drawing is performed on the stroke to be drawn, and the stroke snapshots are used for the other strokes, so that there is no need to redraw all the strokes during the drawing process, thereby improving a drawing efficiency. In addition, there is no need to redraw a large number of small squares corresponding to respective strokes, thereby avoiding a freeze during the drawing process.

### Embodiment 3

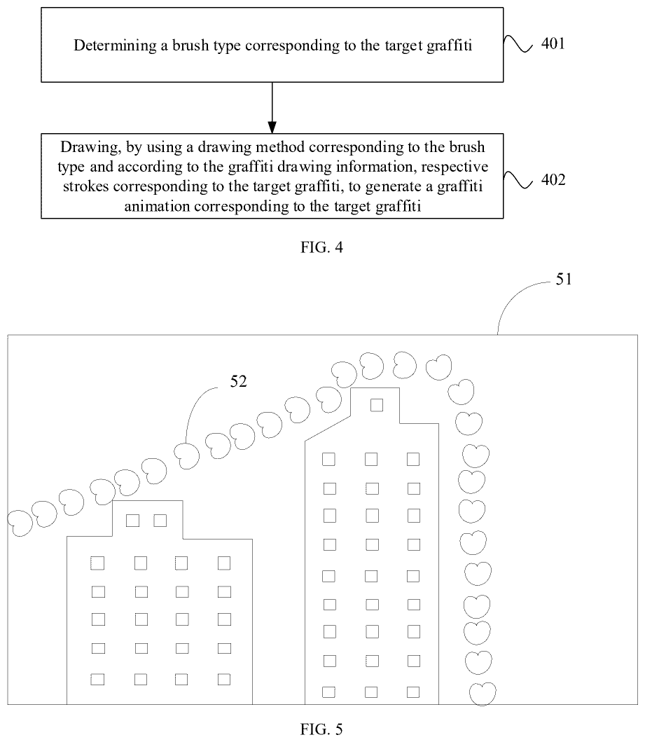

FIG. 4 is a flow diagram of a drawing animation generation method provided by yet another embodiment of the present disclosure. On the basis of any one of the foregoing embodiments, the animation type includes a loop animation type. As shown in FIG. 4, the drawing, by using a drawing method corresponding to the animation type and according to the line drawing information, the at least part of the strokes corresponding to the target line, to generate the drawing animation corresponding to the target line includes following steps.

Step 401: determining a brush type used when the target line is drawn.

Step 402: drawing, by using a drawing method corresponding to the brush type and according to the line drawing information, the at least part of the strokes corresponding to the target line, to generate the drawing animation corresponding to the target line.

In the present embodiment, the animation type may specifically be the loop animation type, and the loop animation type may specifically be to add a random editing element to the target line, and control an edited target line to be played in a loop. For example, at least one of a random jitter, random scaling, a size adjustment, a random offset, and a random rotation may be added to each stroke in the target line.

In an actual application, to optimize a graffiti effect, a plurality of different brush types may be provided. The brush types may include a solid-color brush and a material brush. A color of the solid-color brush may be customized by the user. A stroke drawn by using the material brush may be composed of material cells corresponding to the material brush.

Therefore, for different brush types, respective strokes corresponding to the target line may be drawn according to the line drawing information and by using different drawing methods, to generate the drawing animation corresponding to the target line.

In the drawing animation generation method provided in the present embodiment, a drawing operation of the drawing animation is performed by using the different drawing methods and according to the different brush types, so that an effect of a final generated drawing animation can match a brush type, thereby improving quality of the drawing animation.

Further, on the basis of any one of the foregoing embodiments, the brush type includes a solid-color brush type, and step 402 includes:
for the at least part of the strokes in the target line, adding a preset editing element to stroke bounding boxes corresponding to the strokes, to obtain edited target strokes, where the editing element includes one or more of a rotation element, a scaling element, an offset element, and a movement element; and
performing a combination operation on stroke snapshots associated with the target strokes corresponding to the at least part of the strokes, to obtain the drawing animation.

In the present embodiment, when the brush type is the solid-color brush, the drawing animation may be generated by using the stroke snapshots and the stroke bounding boxes. Therefore, a preset editing element may be added to a stroke bounding box corresponding to each stroke to obtain an edited target stroke, where the preset editing element includes one or more of a rotation element, a scaling element, an offset element, and a movement element which are preset by the user. Alternatively, the preset editing element may include one or more of a random rotation element, a random scaling element, a random offset element, and a random movement element.

After editing operations on respective strokes are completed, the combination operation may be performed on the stroke snapshots associated with the target strokes corresponding to the at least part of the strokes to obtain the drawing animation.

In the drawing animation generation method provided in the present embodiment, when the brush type is the solid-color brush, the preset editing element is added to the bounding box of each stroke, and the combination operation is performed on the stroke snapshots associated with the target strokes corresponding to the at least part of the strokes, so that each stroke in the generated drawing animation can present the editing element, thereby enriching a display effect of the drawing animation, making the generated drawing animation more conform to an actual requirement of the user, and improving the user experience.

Further, on the basis of any one of the foregoing embodiments, the brush type includes a material brush, and a stroke drawn by using the material brush is composed of a plurality of material cells corresponding to the material brush, and step 402 includes:
for each material cell corresponding to the at least part of the strokes in the target line, adding a preset editing element to the material cell, to obtain a target material cell, where the editing element includes one or more of a rotation element, a scaling element, an offset element, and a movement element;
generating an edited target stroke according to the target material cell; and
performing a full drawing operation for the at least part of the target strokes corresponding to the target line to obtain the drawing animation.

In the present embodiment, when the brush type is the material brush, the stroke drawn by using the material brush may be composed of the material cells corresponding to the material brush. Therefore, when the drawing animation is generated, an editing operation needs to be performed on each material cell.

Specifically, for each material cell corresponding to respective strokes in the target line, a preset editing element may be added thereto to obtain an edited target material cell, where the preset editing element includes one or more of a rotation element, a scaling element, an offset element, and a movement element which are preset by the user. Alternatively, the preset editing element may include one or more of a random rotation element, a random scaling element, a random offset element, and a random movement element.

An edited target stroke is generated according to the target material cell. The full drawing operation is performed for the at least part of the target strokes corresponding to the target line to obtain the drawing animation.

FIG. 5 is a diagram of a target line drawn by using a material brush provided by an embodiment of the present disclosure. As shown in FIG. 5, in a target line 51 drawn by using a material brush, each stroke is composed of a plurality of material cells 52 corresponding to the material brush, where the material cell 52 may be in a heart shape.

In the drawing animation generation method provided in the present embodiment, when the brush type is the material brush, a random editing element is added to each material cell corresponding to respective strokes, and the edited target stroke is generated according to the target material cell. The full drawing operation is performed for the at least part of the target strokes corresponding to the target line to obtain the drawing animation, so that each material cell can present the random editing element, thereby enriching the display effect of the drawing animation.

### Embodiment 4

FIG. 6 is a flow diagram of a drawing animation generation method provided by yet another embodiment of the present disclosure. On the basis of any one of the foregoing embodiments, before step 101, the following is further included.

Step 601: acquiring, in response to a drawing operation of the user on a target video in a drawing edit page, line drawing information corresponding to respective strokes drawn by the user.

Step 602: determining, in response to a trigger operation of the user on a preset completion control, all the strokes currently drawn by the user as the target line, and storing the line drawing information corresponding to the target line.

In the present embodiment, the user may perform an editing operation on the target video or a target image on the terminal device. For example, a freehand graffiti may be added to the target video or the target image to obtain the target line.

In an embodiment, in response to the drawing operation of the user on the target video in the drawing edit page, the line drawing information corresponding to respective strokes drawn by the user is acquired. The line drawing information includes a stroke snapshot, a stroke bounding box, and a drawing track corresponding to each stroke in the target line. The stroke snapshot can represent a drawing status of the line at a certain moment, and the stroke bounding box can represent an optimal bounding space of a stroke.

Further, the completion control is further provided in the drawing edit page. When the user completes drawing of the target line, the user may perform a trigger operation on the completion control. Correspondingly, in response to the trigger operation of the user on the preset completion control, all the strokes currently drawn by the user are determined as the target line. To facilitate the user to review the drawing process in a subsequent process to generate the drawing animation, the line drawing information corresponding to the target line may be stored.

Further, on the basis of any one of the foregoing embodiments, after step 602, the method further includes:
performing, in response to a display request triggered by the user for the target line, a combination operation on stroke snapshots corresponding to the drawn target line when the user triggers the completion control and the target video.

In the present embodiment, after the drawing of the target line is completed, the user may also choose not to generate a graffiti video according to the target line. In this case, the target line and the target video may be directly combined to show a final effect to the user.

Specifically, in response to the display request triggered by the user for the target line, the stroke snapshots corresponding to the drawn target line when the user triggers the completion control and the target video may be combined.

In the drawing animation generation method provided in the present embodiment, the line drawing information corresponding to the target line is saved in the drawing process of the target line, so that the drawing animation can be quickly generated based on the line drawing information in the subsequent process, a freeze in a redrawing process is avoided, and the user experience is improved.

### Embodiment 5

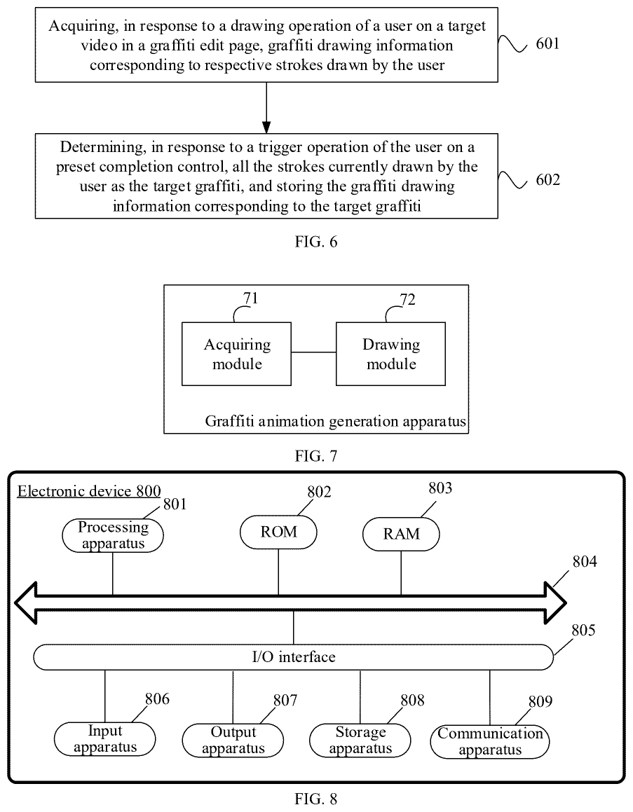

FIG. 7 is a structural diagram of a drawing animation generation apparatus provided by an embodiment of the present disclosure. As shown in FIG. 7, the apparatus includes: an acquiring module 71 and a drawing module 72. The acquiring module 71 is configured to acquire, in response to a drawing animation generation request triggered by a user for a target line, line drawing information corresponding to the target line, where the line drawing information includes a stroke snapshot, a stroke bounding box, and a drawing track corresponding to at least part of strokes in the target line, and the target line is composed of a plurality of strokes. The drawing module 72 is configured to draw, according to the drawing animation generation request and by using the line drawing information, the at least part of the strokes corresponding to the target line, to generate a drawing animation corresponding to the target line.

Further, on the basis of any one of the foregoing embodiments, the drawing animation generation request includes an animation type; and the drawing module is configured to draw, by using a drawing method corresponding to the animation type and according to the line drawing information, the at least part of the strokes corresponding to the target line, to generate the drawing animation corresponding to the target line.

Further, on the basis of any one of the foregoing embodiments, the animation type includes an entrance animation and/or an exit animation; and the drawing module is configured to: determine, according to the line drawing information and preset drawing animation information, a stroke to be drawn corresponding to a current time frame, where the drawing animation information includes a drawing duration and/or a drawing speed corresponding to the drawing animation; perform a drawing operation for the stroke to be drawn to obtain a drawn stroke, and draw, according to the line drawing information, other strokes whose display orders in the target line are before the stroke to be drawn, to obtain the drawing animation.

Further, on the basis of any one of the foregoing embodiments, the drawing module is configured to: determine, according to the line drawing information, stroke snapshots corresponding to the other strokes; and perform a combination operation on the drawn stroke and the stroke snapshots corresponding to the other strokes, to generate the drawing animation corresponding to the target line.

Further, on the basis of any one of the foregoing embodiments, the drawing module is configured to: determine, according to a total length corresponding to all the strokes in the target line and the drawing animation information, a drawing time period corresponding to each stroke; and determine the current time frame, determine a drawing time period matching the current time frame, and determine a stroke corresponding to the drawing time period as the stroke to be drawn.

Further, on the basis of any one of the foregoing embodiments, when the animation type is the entrance animation type, and an animation drawing order is a sequential drawing order, and/or when the animation type is the exit animation type, and the animation drawing order is an inverted drawing order, the drawing module is configured to: determine, according to the drawing animation information, the total length corresponding to all the strokes in the target line, and the drawing track, a first drawing position corresponding to the current time frame and a drawing position corresponding to a next time frame; and perform an incremental drawing operation on a to-be-drawn area between the second drawing position and the first drawing position, until the drawing operation for the stroke to be drawn is completed, to obtain the drawn stroke.

Further, on the basis of any one of the foregoing embodiments, when the animation type is the entrance animation type, and the animation drawing order is an inverted drawing order, and/or when the animation type is the exit animation type, and the animation drawing order is a sequential drawing order, the drawing module is configured to: determine a drawn length corresponding to the stroke to be drawn at the current time frame; determine, according to the drawing animation information and a time difference between the current time frame and a next time frame, a target drawing length corresponding to the next time frame; and perform a full drawing operation for the target drawing length of the stroke to be drawn at the next time frame, to obtain the drawn stroke.

Further, on the basis of any one of the foregoing embodiments, the animation type includes a loop animation; and the drawing module is configured to: determine a brush type used when the target line is drawn; and draw, by using a drawing method corresponding to the brush type and according to the line drawing information, the at least part of the strokes corresponding to the target line, to generate the drawing animation corresponding to the target line.

Further, on the basis of any one of the foregoing embodiments, the brush type includes a solid-color brush, and the drawing module is configured to: for the at least part of the strokes in the target line, add a preset editing element to stroke bounding boxes corresponding to the strokes, to obtain edited target strokes, where the editing element includes one or more of a rotation element, a scaling element, an offset element, and a movement element; and perform a combination operation on stroke snapshots associated with the target strokes corresponding to the at least part of the strokes, to obtain the drawing animation.

Further, on the basis of any one of the foregoing embodiments, the brush type includes a material brush, and a stroke drawn by using the material brush is composed of a plurality of material cells corresponding to the material brush; and the drawing module is configured to: for each material cell corresponding to the at least part of the strokes in the target line, add a preset editing element to the material cell, to obtain a target material cell, where the editing element includes one or more of a rotation element, a scaling element, an offset element, and a movement element; generate an edited target stroke according to the target material cell; and perform a full drawing operation for the at least part of the target strokes corresponding to the target line to obtain the drawing animation.

Further, on the basis of any one of the foregoing embodiments, the apparatus further includes: an acquiring module, configured to acquire, in response to a drawing operation of the user on a target video in a drawing edit page, line drawing information corresponding to respective strokes drawn by the user; and a determining module, configured to determine, in response to a trigger operation of the user on a preset completion control, all the strokes currently drawn by the user as the target line, and store the line drawing information corresponding to the target line.

Further, on the basis of any one of the foregoing embodiments, the apparatus further includes: a combination module, configured to perform, in response to a display request triggered by the user for the target line, a combination operation on stroke snapshots corresponding to the drawn target line when the user triggers the completion control and the target video.

The device provided in the present embodiment may be configured to perform the technical solutions in the method embodiments described above, and implementation principles and technical effects thereof are similar, which will not be repeated in the present embodiment.

### Embodiment 6

To implement the above embodiments, an embodiment of the present disclosure further provides an electronic device, including: a processor and a memory.

The memory stores a computer-executable instruction.

The processor executes the computer-executable instruction stored in the memory, so that the processor executes the drawing animation generation method according to any one of the foregoing embodiments.

FIG. 8 is a structural diagram of an electronic device provided by an embodiment of the present disclosure. As shown in FIG. 8, the electronic device 800 may be a terminal device or a server. The terminal device may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 8 is merely an example, and shall not impose any limitation on functions and scope of use of the embodiments of the present disclosure.

As shown in FIG. 8, the electronic device 800 may include a processing apparatus (for example, a central processor, a graphics processor, etc.) 801 that may execute a variety of appropriate actions and processing according to a program stored in a read only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are connected to each other via a bus 804. An input/output (I/O) interface 805 is also connected to the bus 804.

Generally, following apparatuses may be connected to the I/O interface 805: an input apparatus 806 including, for example, a touchscreen, a touchpad, a keyboard, a mouse, a camera, a microphone, an accelerometer, and a gyroscope, etc.; an output apparatus 807 including, for example, a liquid crystal display (LCD), a speaker, and a vibrator, etc.; the storage apparatus 808 including, for example, a tape and a hard disk, etc.; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the processes described above with reference to the flow diagrams may be implemented as a computer software program. For example, an embodiment of the present disclosure includes a computer program product, which includes a computer program carried on a computer-readable medium, where the computer program includes program code for executing the methods shown in the flow diagrams. In such an embodiment, the computer program may be downloaded from a network through the communication apparatus 809 and installed, installed from the storage apparatus 808, or installed from the ROM 802. When the computer program is executed by the processing apparatus 801, the above-mentioned functions defined in the methods of the embodiments of the present disclosure are executed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a RAM, a ROM, an erasable programmable read only memory (EPROM) or a flash memory, an optic fiber, a portable compact disk read only memory (CD-ROM), an optical storage device, a magnetic storage device, or any suitable combination thereof. In the present disclosure, the computer-readable storage medium may be any tangible medium containing or storing a program that may be used by or in combination with an instruction execution system, an apparatus, or a device. In the present disclosure, the computer-readable signal medium may include a data signal propagated in a baseband or as a part of a carrier, where the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, an apparatus, or a device. The program code contained in the computer-readable medium may be transmitted by any suitable medium, including but not limited to: electric wires, optical cables, radio frequency (RF), etc., or any suitable combination thereof.

An embodiment of the present disclosure further provides a computer-readable storage medium storing computer-executable instructions that, when executed by a processor, implement the drawing animation generation method according to any one of the foregoing embodiments.

An embodiment of the present disclosure further provides a computer program product including a computer program that, when executed by a processor, implements the drawing animation generation method according to any one of the foregoing embodiments.

An embodiment of the present disclosure further provides a computer program that, when executed by a processor, implements the drawing animation generation method according to any one of the foregoing embodiments.

The foregoing computer-readable medium may be contained in the foregoing electronic device. Alternatively, the computer-readable medium may exist independently, without being assembled into the electronic device.

The foregoing computer-readable medium carries one or more programs, and when the one or more programs are executed by the electronic device, the electronic device is enabled to execute the methods shown in the foregoing embodiments.

Computer program codes for executing operations in the present disclosure may be written in one or more programming languages or a combination thereof, where the programming languages include an object-oriented programming language such as Java, Smalltalk, and C++, and further include conventional procedural programming languages, such as “C” language or similar programming languages. The program codes may be completely executed on a computer of a user, partially executed on a computer of a user, executed as an independent software package, partially executed on a computer of a user and partially executed on a remote computer, or completely executed on a remote computer or server. In a case involving a remote computer, the remote computer may be connected to the computer of the user over any type of network, including a local area network (LAN) or a wide area network (WAN), or may be connected to an external computer (for example, connected over the Internet using an Internet service provider).

The flow diagrams and block diagrams in the drawings illustrate possible system architectures, functions, and operations of the system, the method, and the computer program product according to various embodiments of the present disclosure. In this regard, each block in the flow diagrams or block diagrams may represent a module, a program segment, or a part of codes, and the module, the program segment, or the part of codes contains one or more executable instructions for implementing specified logical functions. It should also be noted that, in some alternative implementations, functions marked in the blocks may also occur in an order different from that marked in the drawings. For example, two blocks shown in succession may actually be executed substantially in parallel, or may sometimes be executed in a reverse order, depending on a function involved. It should also be noted that each block in the block diagrams and/or the flow diagrams, and a combination of blocks in the block diagrams and/or the flow diagrams may be implemented by a dedicated hardware-based system that executes specified functions or operations, or may be implemented by a combination of dedicated hardware and computer instructions.

Units described in the embodiments of the present disclosure may be implemented by software, or may be implemented by hardware. A name of a unit does not constitute a limitation on the unit in some cases. For example, a first acquiring unit may also be described as a “unit that acquires at least two Internet protocol addresses”.

The functions described herein above may be executed at least partially by one or more hardware logic components. For example, without limitation, exemplary types of hardware logic components that may be used include: a field programmable gate array (FPGA), an application specific integrated circuit (ASIC), application specific standard parts (ASSP), a system on chip (SOC), a complex programmable logic device (CPLD), and the like.

In the context of the present disclosure, a machine-readable medium may be a tangible medium that may contain or store a program used by or in combination with an instruction execution system, an apparatus, or a device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a RAM, a ROM, an EPROM or a flash memory, an optic fiber, a CD-ROM, an optical storage device, a magnetic storage device, or any suitable combination thereof.

In a first aspect, according to one or more embodiments of the present disclosure, there is provided a drawing animation generation method, including:
acquiring, in response to a drawing animation generation request triggered by a user for a target line, line drawing information corresponding to the target line, where the line drawing information includes a stroke snapshot, a stroke bounding box, and a drawing track which are corresponding to at least part of strokes in the target line, and the target line is composed of a plurality of strokes; and
drawing, according to the drawing animation generation request and by using the line drawing information, the at least part of the strokes corresponding to the target line, to generate a drawing animation corresponding to the target line.

According to one or more embodiments of the present disclosure, the drawing animation generation request includes an animation type; and
the drawing, according to the drawing animation generation request and by using the line drawing information, the at least part of the strokes corresponding to the target line, to generate a drawing animation corresponding to the target line includes:
drawing, by using a drawing method corresponding to the animation type and according to the line drawing information, the at least part of the strokes corresponding to the target line, to generate the drawing animation corresponding to the target line.

According to one or more embodiments of the present disclosure, the animation type includes an entrance animation and/or an exit animation; and
the drawing, by using a drawing method corresponding to the animation type and according to the line drawing information, the at least part of the strokes corresponding to the target line, to generate the drawing animation corresponding to the target line includes:
determining, according to the line drawing information and preset drawing animation information, a stroke to be drawn corresponding to a current time frame, where the drawing animation information includes a drawing duration and/or a drawing speed corresponding to the drawing animation; and
performing a drawing operation for the stroke to be drawn to obtain a drawn stroke, and drawing, according to the line drawing information, other strokes whose display orders in the target line are before the stroke to be drawn, to obtain the drawing animation.

According to one or more embodiments of the present disclosure, the performing a drawing operation for the stroke to be drawn to obtain a drawn stroke, and drawing, according to the line drawing information, other strokes whose display orders in the target line are before the stroke to be drawn, to obtain the drawing animation includes:
determining, according to the line drawing information, stroke snapshots corresponding to the other strokes; and
performing a combination operation on the drawn stroke and the stroke snapshots corresponding to the other strokes, to generate the drawing animation corresponding to the target line.

According to one or more embodiments of the present disclosure, the determining, according to the line drawing information and preset drawing animation information, a stroke to be drawn corresponding to a current time frame includes:
determining, according to a total length corresponding to all the strokes in the target line and the drawing animation information, a drawing time period corresponding to each stroke; and
determining the current time frame, determining a drawing time period matching the current time frame, and determining a stroke corresponding to the drawing time period as the stroke to be drawn.

According to one or more embodiments of the present disclosure, when the animation type is the entrance animation type, and an animation drawing order is a sequential drawing order, and/or when the animation type is the exit animation type, and the animation drawing order is an inverted drawing order, the performing a drawing operation for the stroke to be drawn to obtain a drawn stroke includes:
determining, according to the drawing animation information, the total length corresponding to all the strokes in the target line, and the drawing track, a first drawing position corresponding to the current time frame and a drawing position corresponding to a next time frame; and
performing an incremental drawing operation on a to-be-drawn area between the second drawing position and the first drawing position, until the drawing operation for the stroke to be drawn is completed, to obtain the drawn stroke.

According to one or more embodiments of the present disclosure, when the animation type is the entrance animation type, and the animation drawing order is an inverted drawing order, and/or when the animation type is the exit animation type, and the animation drawing order is a sequential drawing order, the performing a drawing operation for the stroke to be drawn to obtain a drawn stroke includes:
determining a drawn length corresponding to the stroke to be drawn at the current time frame;
determining, according to the drawing animation information and a time difference between the current time frame and the next time frame, a target drawing length corresponding to the next time frame; and
performing a full drawing operation for the target drawing length of the stroke to be drawn at the next time frame, to obtain the drawn stroke.

According to one or more embodiments of the present disclosure, the animation type includes a loop animation; and
the drawing, by using a drawing method corresponding to the animation type and according to the line drawing information, the at least part of the strokes corresponding to the target line, to generate the drawing animation corresponding to the target line includes:
determining a brush type used when the target line is drawn; and
drawing, by using a drawing method corresponding to the brush type and according to the line drawing information, the at least part of the strokes corresponding to the target line, to generate the drawing animation corresponding to the target line.

According to one or more embodiments of the present disclosure, the brush type includes a solid-color brush, and the drawing, by using a drawing method corresponding to the animation type and according to the line drawing information, the at least part of the strokes corresponding to the target line, to generate the drawing animation corresponding to the target line includes:
for the at least part of the strokes in the target line, adding a preset editing element to stroke bounding boxes corresponding to the strokes, to obtain edited target strokes, where the editing element includes one or more of a rotation element, a scaling element, an offset element, and a movement element; and
performing a combination operation on stroke snapshots associated with the target strokes corresponding to the at least part of the strokes, to obtain the drawing animation.

According to one or more embodiments of the present disclosure, the brush type includes a material brush, and a stroke drawn by using the material brush is composed of a plurality of material cells corresponding to the material brush; and
the drawing, by using a drawing method corresponding to the animation type and according to the line drawing information, the at least part of the strokes corresponding to the target line, to generate the drawing animation corresponding to the target line includes:
for each material cell corresponding to the at least part of the strokes in the target line, adding a preset editing element to the material cell, to obtain a target material cell, where the editing element includes one or more of a rotation element, a scaling element, an offset element, and a movement element;
generating an edited target stroke according to the target material cell; and
performing a full drawing operation for the at least part of the target strokes corresponding to the target line to obtain the drawing animation.

According to one or more embodiments of the present disclosure, before the acquiring, in response to a drawing animation generation request triggered by a user for a target line, line drawing information corresponding to the target line, the method further includes:
acquiring, in response to a drawing operation of the user on a target video in a drawing edit page, line drawing information corresponding to respective strokes drawn by the user; and
determining, in response to a trigger operation of the user on a preset completion control, all the strokes currently drawn by the user as the target line, and storing the line drawing information corresponding to the target line.

According to one or more embodiments of the present disclosure, after the storing the line drawing information corresponding to the target line, the method further includes:
performing, in response to a display request triggered by the user for the target line, a combination operation on stroke snapshots corresponding to the drawn target line when the user triggers the completion control and the target video.

In a second aspect, according to one or more embodiments of the present disclosure, there is provided a drawing animation generation apparatus, including:
an acquiring module configured to acquire, in response to a drawing animation generation request triggered by a user for a target line, line drawing information corresponding to the target line, where the line drawing information includes a stroke snapshot, a stroke bounding box, and a drawing track corresponding to at least part of strokes in the target line, and the target line is composed of a plurality of strokes; and
a drawing module configured to draw, according to the drawing animation generation request and by using the line drawing information, the at least part of the strokes corresponding to the target line, to generate a drawing animation corresponding to the target line.

According to one or more embodiments of the present disclosure, the drawing animation generation request includes an animation type; and the drawing module is configured to draw, by using a drawing method corresponding to the animation type and according to the line drawing information, the at least part of the strokes corresponding to the target line, to generate the drawing animation corresponding to the target line.

According to one or more embodiments of the present disclosure, the animation type includes an entrance animation and/or an exit animation; and the drawing module is configured to: determine, according to the line drawing information and preset drawing animation information, a stroke to be drawn corresponding to a current time frame, where the drawing animation information includes a drawing duration and/or a drawing speed corresponding to the drawing animation; perform a drawing operation for the stroke to be drawn to obtain a drawn stroke, and draw, according to the line drawing information, other strokes whose display orders in the target line are before the stroke to be drawn, to obtain the drawing animation.

According to one or more embodiments of the present disclosure, the drawing module is configured to: determine, according to the line drawing information, stroke snapshots corresponding to the other strokes; and perform a combination operation on the drawn stroke and the stroke snapshots corresponding to the other strokes, to generate the drawing animation corresponding to the target line.

According to one or more embodiments of the present disclosure, the drawing module is configured to: determine, according to a total length corresponding to all the strokes in the target line and the drawing animation information, a drawing time period corresponding to each stroke; and determine the current time frame, determine a drawing time period matching the current time frame, and determine a stroke corresponding to the drawing time period as the stroke to be drawn.

According to one or more embodiments of the present disclosure, when the animation type is the entrance animation type, and an animation drawing order is a sequential drawing order, and/or when the animation type is the exit animation type, and the animation drawing order is an inverted drawing order, the drawing module is configured to: determine, according to the drawing animation information, the total length corresponding to all the strokes in the target line, and the drawing track, a first drawing position corresponding to the current time frame and a drawing position corresponding to a next time frame; and perform an incremental drawing operation on a to-be-drawn area between the second drawing position and the first drawing position, until the drawing operation for the stroke to be drawn is completed, to obtain the drawn stroke.

According to one or more embodiments of the present disclosure, when the animation type is the entrance animation type, and the animation drawing order is an inverted drawing order, and/or when the animation type is the exit animation type, and the animation drawing order is a sequential drawing order, the drawing module is configured to: determine a drawn length corresponding to the stroke to be drawn at the current time frame; determine, according to the drawing animation information and a time difference between the current time frame and a next time frame, a target drawing length corresponding to the next time frame; and perform a full drawing operation for the target drawing length of the stroke to be drawn at the next time frame, to obtain the drawn stroke.

According to one or more embodiments of the present disclosure, the animation type includes a loop animation; and the drawing module is configured to: determine a brush type used when the target line is drawn; and draw, by using a drawing method corresponding to the brush type and according to the line drawing information, the at least part of the strokes corresponding to the target line, to generate the drawing animation corresponding to the target line.

According to one or more embodiments of the present disclosure, the brush type includes a solid-color brush, and the drawing module is configured to: for the at least part of the strokes in the target line, add a preset editing element to stroke bounding boxes corresponding to the strokes, to obtain edited target strokes, where the editing element includes one or more of a rotation element, a scaling element, an offset element, and a movement element; and perform a combination operation on stroke snapshots associated with the target strokes corresponding to the at least part of the strokes, to obtain the drawing animation.

According to one or more embodiments of the present disclosure, the brush type includes a material brush, and a stroke drawn by using the material brush is composed of a plurality of material cells corresponding to the material brush; and the drawing module is configured to: for each material cell corresponding to the at least part of the strokes in the target line, add a preset editing element to the material cell, to obtain a target material cell, where the editing element includes one or more of a rotation element, a scaling element, an offset element, and a movement element; generate an edited target stroke according to the target material cell; and perform a full drawing operation for the at least part of the target strokes corresponding to the target line to obtain the drawing animation.

According to one or more embodiments of the present disclosure, the apparatus further includes: an acquiring module configured to acquire, in response to a drawing operation of the user on a target video in a drawing edit page, line drawing information corresponding to respective strokes drawn by the user; and a determining module configured to determine, in response to a trigger operation of the user on a preset completion control, all the strokes currently drawn by the user as the target line, and store the line drawing information corresponding to the target line.

According to one or more embodiments of the present disclosure, the apparatus further includes: a combination module configured to perform, in response to a display request triggered by the user for the target line, a combination operation on stroke snapshots corresponding to the drawn target line when the user triggers the completion control and the target video.

In a third aspect, according to one or more embodiments of the present disclosure, there is provided an electronic device, including: at least one processor and a memory;
the memory storing computer-executable instructions; and
the at least one processor executing the computer-executable instructions stored in the memory, so that the at least one processor executes the drawing animation generation method described in the foregoing first aspect and various possible designs of the first aspect.

In a fourth aspect, according to one or more embodiments of the present disclosure, there is provided a computer-readable storage medium storing computer-executable instructions that, when executed by a processor, implement the drawing animation generation method described in the foregoing first aspect and various possible designs of the first aspect.

In a fifth aspect, according to one or more embodiments of the present disclosure, there is provided a computer program product including a computer program that, when executed by a processor, implements the drawing animation generation method described in the foregoing first aspect and various possible designs of the first aspect.

In a sixth aspect, according to one or more embodiments of the present disclosure, there is provided a computer program that, when executed by a processor, implements the drawing animation generation method described in the foregoing first aspect and various possible designs of the first aspect.

The foregoing descriptions are merely preferred embodiments of the present disclosure and explanations of the applied technical principles. Persons skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure, for example, a technical solution formed by replacing the foregoing features with technical features with similar functions disclosed in the present disclosure (but not limited thereto).

In addition, although various operations are depicted in a specific order, it should not be understood as requiring these operations to be executed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in a single embodiment may also be implemented in a plurality of embodiments individually or in any suitable subcombination.

Although the subject matter has been described in language specific to structural features and/or logical actions of methods, it should be understood that the subject matter specified in the appended claims is not necessarily limited to the specific features or actions described above. In contrast, the specific features and actions described above are merely exemplary forms of implementing the claims.

1. A drawing animation generation method, comprising:
acquiring, in response to a drawing animation generation request triggered by a user for a target line, line drawing information corresponding to the target line, wherein the line drawing information comprises a stroke snapshot, a stroke bounding box, and a drawing track which are corresponding to at least part of strokes in the target line, and the target line is composed of a plurality of strokes; and
drawing, according to the drawing animation generation request and by using the line drawing information, the at least part of the strokes corresponding to the target line, to generate a drawing animation corresponding to the target line.

2. The method according to claim 1, wherein the drawing animation generation request comprises an animation type; and
the drawing, according to the drawing animation generation request and by using the line drawing information, the at least part of the strokes corresponding to the target line, to generate a drawing animation corresponding to the target line comprises:
drawing, by using a drawing method corresponding to the animation type and according to the line drawing information, the at least part of the strokes corresponding to the target line, to generate the drawing animation corresponding to the target line.

3. The method according to claim 2, wherein the animation type comprises at least one of an entrance animation and/or an exit animation; and
the drawing, by using a drawing method corresponding to the animation type and according to the line drawing information, the at least part of the strokes corresponding to the target line, to generate the drawing animation corresponding to the target line comprises:
determining, according to the line drawing information and preset drawing animation information, a stroke to be drawn corresponding to a current time frame, wherein the drawing animation information comprises at least one of a drawing duration and a drawing speed corresponding to the drawing animation; and
performing a drawing operation for the stroke to be drawn to obtain a drawn stroke, and drawing, according to the line drawing information, other strokes whose display orders in the target line are before the stroke to be drawn, to obtain the drawing animation.

4. The method according to claim 3, wherein the performing a drawing operation for the stroke to be drawn to obtain a drawn stroke, and drawing, according to the line drawing information, other strokes whose display orders in the target line are before the stroke to be drawn, to obtain the drawing animation comprises:
determining, according to the line drawing information, stroke snapshots corresponding to the other strokes; and
performing a combination operation on the drawn stroke and the stroke snapshots corresponding to the other strokes, to generate the drawing animation corresponding to the target line.

5. The method according to claim 3, wherein the determining, according to the line drawing information and preset drawing animation information, a stroke to be drawn corresponding to a current time frame comprises:
determining, according to a total length corresponding to all the strokes in the target line and the drawing animation information, a drawing time period corresponding to each stroke; and
determining the current time frame, determining a drawing time period matching the current time frame, and determining a stroke corresponding to the drawing time period as the stroke to be drawn.

6. The method according to claim 3, wherein when the animation type is the entrance animation type, and an animation drawing order is a sequential drawing order, or when the animation type is the exit animation type, and the animation drawing order is an inverted drawing order, the performing a drawing operation for the stroke to be drawn to obtain a drawn stroke comprises:
determining, according to the drawing animation information, a total length corresponding to all the strokes in the target line, and the drawing track, a first drawing position corresponding to the current time frame and a drawing position corresponding to a next time frame; and
performing an incremental drawing operation on a to-be-drawn area between the second drawing position and the first drawing position, until the drawing operation for the stroke to be drawn is completed, to obtain the drawn stroke.

7. The method according to claim 3, wherein when the animation type is the entrance animation type, and an animation drawing order is an inverted drawing order, or when the animation type is the exit animation type, and the animation drawing order is a sequential drawing order, the performing a drawing operation for the stroke to be drawn to obtain a drawn stroke comprises:
determining a drawn length corresponding to the stroke to be drawn at the current time frame;
determining, according to the drawing animation information and a time difference between the current time frame and the next time frame, a target drawing length corresponding to the next time frame; and
performing a full drawing operation for the target drawing length of the stroke to be drawn at the next time frame, to obtain the drawn stroke.

8. The method according to claim 2, wherein the animation type comprises a loop animation; and
the drawing, by using a drawing method corresponding to the animation type and according to the line drawing information, the at least part of the strokes corresponding to the target line, to generate the drawing animation corresponding to the target line comprises:
determining a brush type used when the target line is drawn; and
drawing, by using a drawing method corresponding to the brush type and according to the line drawing information, the at least part of the strokes corresponding to the target line, to generate the drawing animation corresponding to the target line.

9. The method according to claim 8, wherein the brush type comprises a solid-color brush, and the drawing, by using a drawing method corresponding to the animation type and according to the line drawing information, the at least part of the strokes corresponding to the target line, to generate the drawing animation corresponding to the target line comprises:
for the at least part of the strokes in the target line, adding a preset editing element to stroke bounding boxes corresponding to the strokes in the target line, to obtain edited target strokes, wherein the editing element comprises one or more of a rotation element, a scaling element, an offset element, and a movement element; and
performing a combination operation on stroke snapshots associated with the target strokes corresponding to the at least part of the strokes, to obtain the drawing animation.

10. The method according to claim 8, wherein the brush type comprises a material brush, and a stroke drawn by using the material brush is composed of a plurality of material cells corresponding to the material brush; and
the drawing, by using a drawing method corresponding to the animation type and according to the line drawing information, the at least part of the strokes corresponding to the target line, to generate the drawing animation corresponding to the target line comprises:
for each material cell corresponding to the at least part of the strokes in the target line, adding a preset editing element to the material cell, to obtain a target material cell, wherein the editing element comprises one or more of a rotation element, a scaling element, an offset element, and a movement element;
generating an edited target stroke according to the target material cell; and
performing a full drawing operation for the at least part of the target strokes corresponding to the target line to obtain the drawing animation.

11. The method according to claim 1, wherein before the acquiring, in response to a drawing animation generation request triggered by a user for a target line, line drawing information corresponding to the target line, the method further comprises:
acquiring, in response to a drawing operation of the user on a target video in a drawing edit page, line drawing information corresponding to respective strokes drawn by the user; and
determining, in response to a trigger operation of the user on a preset completion control, all the strokes currently drawn by the user as the target line, and storing the line drawing information corresponding to the target line.

12. The method according to claim 11, wherein after the storing the line drawing information corresponding to the target line, the method further comprises:
performing, in response to a display request triggered by the user for the target line, a combination operation on stroke snapshots corresponding to the drawn target line when the user triggers the completion control and the target video.

13. A drawing animation generation apparatus, comprising:
a processor and a memory; wherein
the memory stores a computer-executable instruction; and
the processor executes the computer-executable instruction stored in the memory, to enable the processor to:
acquire, in response to a drawing animation generation request triggered by a user for a target line, line drawing information corresponding to the target line, wherein the line drawing information comprises a stroke snapshot, a stroke bounding box, and a drawing track which are corresponding to at least part of strokes in the target line, and the target line is composed of a plurality of strokes; and
draw, according to the drawing animation generation request and by using the line drawing information, the at least part of the strokes corresponding to the target line, to generate a drawing animation corresponding to the target line.

14. (canceled)

15. A non-transitory computer-readable storage medium storing a computer-executable instruction that, when executed by a processor, enables the processor to:
acquire, in response to a drawing animation generation request triggered by a user for a target line, line drawing information corresponding to the target line, wherein the line drawing information comprises a stroke snapshot, a stroke bounding box, and a drawing track which are corresponding to at least part of strokes in the target line, and the target line is composed of a plurality of strokes; and
draw, according to the drawing animation generation request and by using the line drawing information, the at least part of the strokes corresponding to the target line, to generate a drawing animation corresponding to the target line.

16. (canceled)

17. (canceled)

18. The apparatus according to claim 13, wherein the drawing animation generation request comprises an animation type, and the processor is further enabled to:
draw, by using a drawing method corresponding to the animation type and according to the line drawing information, the at least part of the strokes corresponding to the target line, to generate the drawing animation corresponding to the target line.

19. The apparatus according to claim 18, wherein the animation type comprises at least one of an entrance animation and an exit animation, and the processor is further enabled to:
determine, according to the line drawing information and preset drawing animation information, a stroke to be drawn corresponding to a current time frame, wherein the drawing animation information comprises at least one of a drawing duration and a drawing speed corresponding to the drawing animation; and
perform a drawing operation for the stroke to be drawn to obtain a drawn stroke, and draw, according to the line drawing information, other strokes whose display orders in the target line are before the stroke to be drawn, to obtain the drawing animation.

20. The apparatus according to claim 19, wherein the processor is further enabled to:
determine, according to the line drawing information, stroke snapshots corresponding to the other strokes; and
perform a combination operation on the drawn stroke and the stroke snapshots corresponding to the other strokes, to generate the drawing animation corresponding to the target line.

21. The apparatus according to claim 19, wherein the processor is further enabled to:
determine, according to a total length corresponding to all the strokes in the target line and the drawing animation information, a drawing time period corresponding to each stroke; and
determine the current time frame, determine a drawing time period matching the current time frame, and determine a stroke corresponding to the drawing time period as the stroke to be drawn.

22. The apparatus according to claim 19, wherein when the animation type is the entrance animation type, and an animation drawing order is a sequential drawing order, or when the animation type is the exit animation type, and the animation drawing order is an inverted drawing order, the processor is further enabled to:
determine, according to the drawing animation information, the total length corresponding to all the strokes in the target line, and the drawing track, a first drawing position corresponding to the current time frame and a drawing position corresponding to a next time frame; and
perform an incremental drawing operation on a to-be-drawn area between the second drawing position and the first drawing position, until the drawing operation for the stroke to be drawn is completed, to obtain the drawn stroke.

23. The apparatus according to claim 19, wherein when the animation type is the entrance animation type, and the animation drawing order is an inverted drawing order, or when the animation type is the exit animation type, and the animation drawing order is a sequential drawing order, the processor is further enabled to:
determine a drawn length corresponding to the stroke to be drawn at the current time frame; determine, according to the drawing animation information and a time difference between the current time frame and a next time frame, a target drawing length corresponding to the next time frame; and perform a full drawing operation for the target drawing length of the stroke to be drawn at the next time frame, to obtain the drawn stroke.
